(19) United States
(12) Patent Application Publication
(10) Pub. No.: US 2006/0049735 A1
(43) Pub. Date: Mar. 9, 2006

(54) Surface light source device and back light unit having the same

(75) Inventors: Ki-Yeon Lee, Suwon-si (KR); Seog-Hyun Cho, Seoul (KR); Jae-Hyeon Ko, Suwon-si (KR)

Correspondence Address: MAYER, BROWN, ROWE & MAW LLP, 1909 K STREET, N.W., WASHINGTON, DC, 20006, US

(73) Assignee: SAMSUNG CORNING CO., LTD.

(21) Appl. No.: 11/206,826

(22) Filed: Aug. 19, 2005

(30) Foreign Application Priority Data
Sep. 7, 2004 (KR) 10-2004-71072

(51) Int. Cl. H01J 11/00; G02B 6/00; H01J 65/00

(52) U.S. Cl. 313/234; 362/551; 313/607

(57) ABSTRACT

A surface light source device includes a light source body having a plurality of discharge spaces into which a discharge gas is injected, an external electrode provided on the outer face of the light source body to apply a discharge voltage to the discharge gas so as to generate plasma in the light source body, and a porous internal electrode arranged in the light source body to provide secondary electrons to the plasma, thereby properly maintaining the plasma. The porous internal electrode includes a porous member, and a conductive layer formed on an outer face of the porous member. The secondary electrons are continuously emitted from the porous internal electrode so that an amount of the plasma is steadily maintained.

### CROSS REFERENCE TO RELATED APPLICATIONS

This application claims priority under 35 USC § 119 to Korean Patent Application No. 2004-71072, filed on Sep. 07, 2004, the contents of which are herein incorporated by reference in its entirety.

### BACKGROUND OF THE INVENTION

1. Field of the Invention

The present invention relates to a surface light source device and back light unit having the same. More particularly, the present invention relates to a surface light source device having an electrode that is capable of generating large quantities of secondary electrons and a back light unit having the surface light source device.

2. Description of the Related Art

Generally, a liquid crystal using a liquid crystal display (LCD) apparatus has electrical and optical characteristics. In the LCD apparatus, the arrangement of the liquid crystal may vary in response to a direction of an electric field applied thereto, and a light transmittance thereof may be changed in accordance with the arrangement thereof.

The LCD apparatus displays an image using the electric and optical characteristics of the liquid crystal. The LCD apparatus is advantageously smaller and lighter than a cathode ray tube (CRT) type display device. Thus, the LCD apparatus is widely used in various electronic apparatus, for example, such as a portable computer, communication equipment, a liquid crystal television receiver set, an aerospace device, etc.

To display the image, the LCD apparatus requires a liquid crystal controlling part for controlling the liquid crystal and a light supplying part for supplying a light to the light controlling part.

The liquid crystal controlling part includes a pixel electrode disposed on a first substrate, a common electrode positioned on a second substrate corresponding to the first substrate, and the liquid crystal interposed between the pixel electrode and the common electrode. The liquid crystal controlling part includes a plurality of the pixel electrodes corresponding to a resolution, and the common electrode is disposed at a position corresponding to the pixel electrodes. A plurality of thin film transistors (TFTs) is electrically connected to the pixel electrodes to supply a pixel voltage having a different level from one another to the pixel electrodes, respectively. A reference voltage is applied to the common electrode. The pixel electrode and the common electrode may include a transparent conductive material.

The light supplying part supplies the liquid crystal of the liquid crystal controlling part with the light. The light successively passes through the pixel electrode, the liquid crystal, and the common electrode. A display quality of an image that has passed through the liquid crystal is largely influenced by a luminance and a uniformity of the luminance of the light that is generated from the light supplying part. The display quality of the LCD apparatus is enhanced in proportion to the luminance and the uniformity of the luminance of the light.

The light supplying part of the conventional LCD apparatus includes a cold cathode fluorescent lamp (CCFL) having a bar shape or a light emitting diode (LED) having a dot shape. The CCFL has advantageous characteristics, for example, such as high luminance, long lifetime, and small heat value in comparison with an incandescent lamp, etc. Therefore, the LED has advantageous characteristics, for example, high luminance and so on. However, The CCFL and the LED have non-uniform luminance.

Therefore, the light supplying part having a light source such as the CCFL or LED includes an optical member, for example, such as a light guide panel (LGP), a diffusion sheet, and a prism sheet, etc. so as to enhance the uniformity of the luminance of the light that is generated from the light supplying part. Thus, there is a problem that dimensions such as a volume and a weight of the LCD apparatus having the CCFL or the LED are increased in proportion to a dimension of the optical member.

In recent years, a surface light source having a flat shape has been developed so as to solve the above problem.

FIG. 1 is a perspective view illustrating a conventional surface light source device and FIG. 2 is a cross sectional view taken along a line II-II′ in FIG. 1.

Referring to FIGS. 1 and 2, a conventional surface light source includes a light source body 10 and an external electrode 30. The light source body 10 includes a first substrate 11, and a second substrate 12 disposed on the first substrate 11. The second substrate 12 has a plurality of partition wall portions 13 integrally formed on the second substrate 12. The partition wall portions 13 make contact with the first substrate 11 to form a plurality of discharge spaces 20 into which a discharge gas is injected. Adjacent two partition wall portions 13 have a width of about 3 mm to about 5 mm to suppress a generating of a current drift effect between the discharge spaces through the partition wall portion 13. In addition, a gas passage 40 through which the discharge gas flows is formed through the partition wall portion 13. A pair of external electrodes 30 surrounds outer faces of the first and second substrates 11 and 12.

However, in the conventional surface light source device, since a relatively high voltage dropping effect is generated in a non-light-emitting region surrounded by the external electrode 30, ions in the discharge spaces are accelerated so that an energy consumption is relatively high. Further, the conventional surface light source device has inferior luminance characteristics. Therefore, in the conventional surface light source, an initial discharge voltage is excessively high and power consumption in the non-light-emitting region is too great. As a result, efficiency for converting energy into a light in a light-emitting region is greatly decreased.

### SUMMARY OF THE INVENTION

The present invention provides a surface light source device that is capable of generating secondary electrons in a discharge space to improve efficiency for generating plasma.

The present invention also provides a back light unit having the above-mentioned surface light source device as a light source.

A surface light source device in accordance with one aspect of the present invention includes a light source body having a plurality of discharge spaces into which a discharge gas is injected. An external electrode for applying a discharge voltage to the discharge gas to generate plasma is provided on the outer face of the light source body. A porous internal electrode for providing secondary electrons to the plasma is disposed in the light source body.

According to one embodiment, the light source body includes a first substrate, a second substrate positioned over the first substrate, a sealing member interposed between the first and second substrates to define an inner space that is isolated from the exterior, and partition walls for dividing the internal space into a plurality of the discharge spaces.

According to another embodiment, the light source body includes a first substrate, and a second substrate having partition wall portions that are integrally formed with the second substrate. The partition wall portions make contact with the first substrate to form the discharge spaces. The partition wall portions have a width of about 3 mm to about 5 mm to suppress a current drift effect.

According to still another embodiment, the porous internal electrode includes a porous member, and a conductive layer formed on an outer face of the porous member.

A back light unit in accordance with another aspect of the present invention includes a surface light source device, a case for receiving the surface light source device, an optical member interposed between the surface light source device and the case, and an inverter for applying a discharge voltage to the surface light source device. The surface light source device includes a light source body having a plurality of discharge spaces into which a discharge gas is injected, an external electrode, which applies a voltage to the discharge gas to generate plasma, provided on the outer face of the light source body, and an porous internal electrode arranged in the light source body to provide secondary electrons to the plasma.

According to the present invention, the intensity of the electric field is increased due to the secondary electrons supplied from the porous internal electrode so that an initial discharge voltage may be decreased. Further, cathode-dropping voltage that is required to properly maintain the plasma may be decreased due to the secondary electrons so that a voltage consumed in the non-light emitting region may be reduced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a perspective view illustrating a conventional surface light source device;

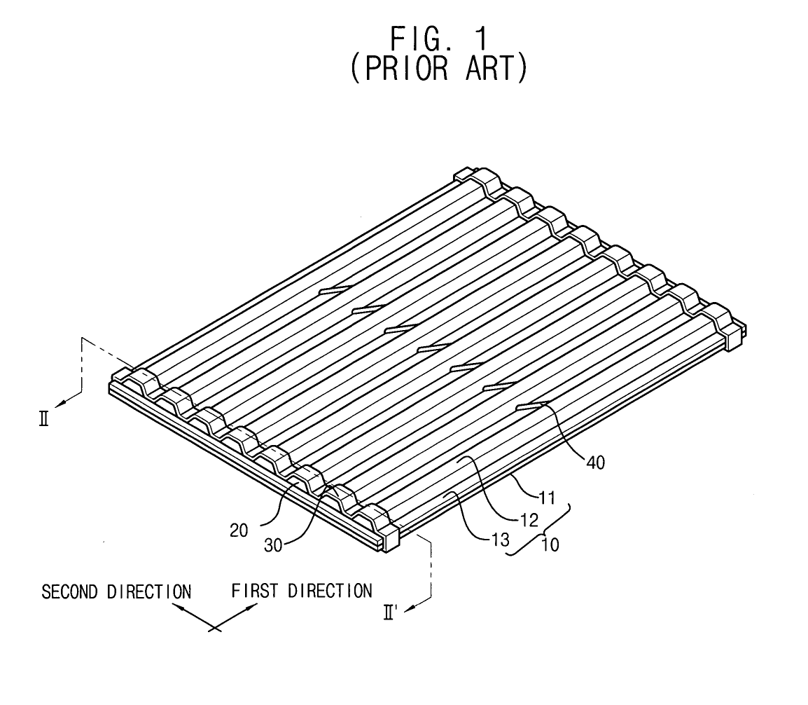

FIG. 2 is a cross sectional view taken along a line II-II′ in FIG. 1;

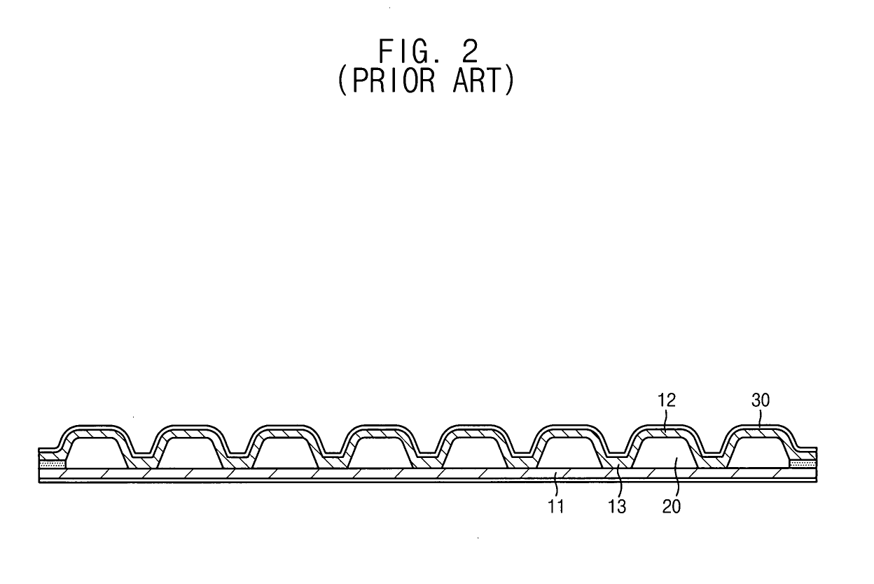

FIG. 3 is a perspective view illustrating a surface light source device in accordance with a first exemplary embodiment of the present invention;

FIG. 4 is a cross sectional view taken along a line IV-IV′ in FIG. 3;

FIG. 5 is an enlarged cross sectional view illustrating a porous internal electrode in FIG. 4;

FIG. 6 is a perspective view illustrating a surface light source device in accordance with a second exemplary embodiment of the present invention;

FIG. 7 is a cross sectional view taken along a line VII-VII′ in FIG. 6;

FIG. 8 is a perspective view illustrating a surface light source device in accordance with a third exemplary embodiment of the present invention;

FIG. 9 is a cross sectional view taken along a line IX-IX′ in FIG. 8; and

FIG. 10 is an exploded perspective view illustrating a back light unit in accordance with a fourth embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Embodiment 1

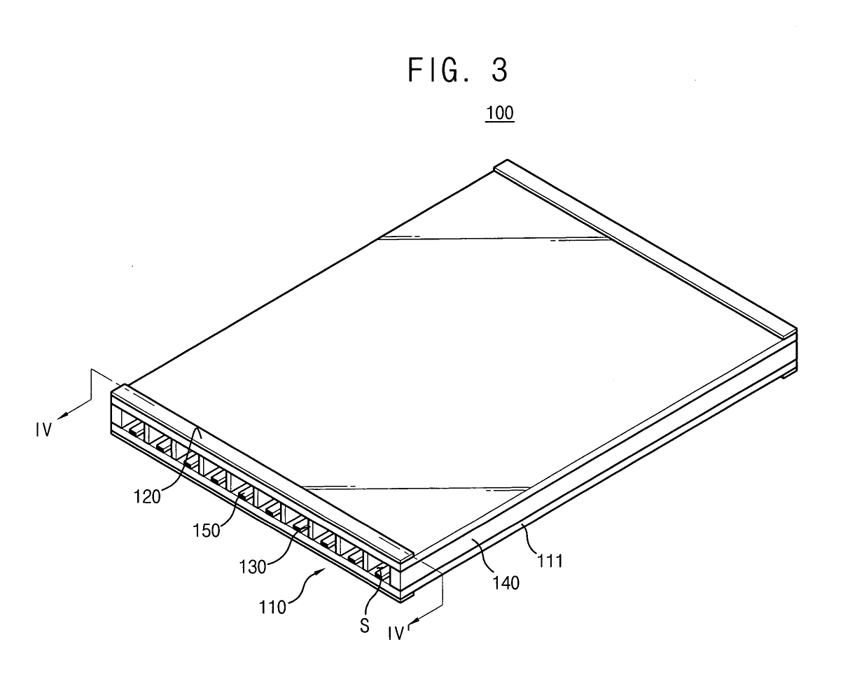

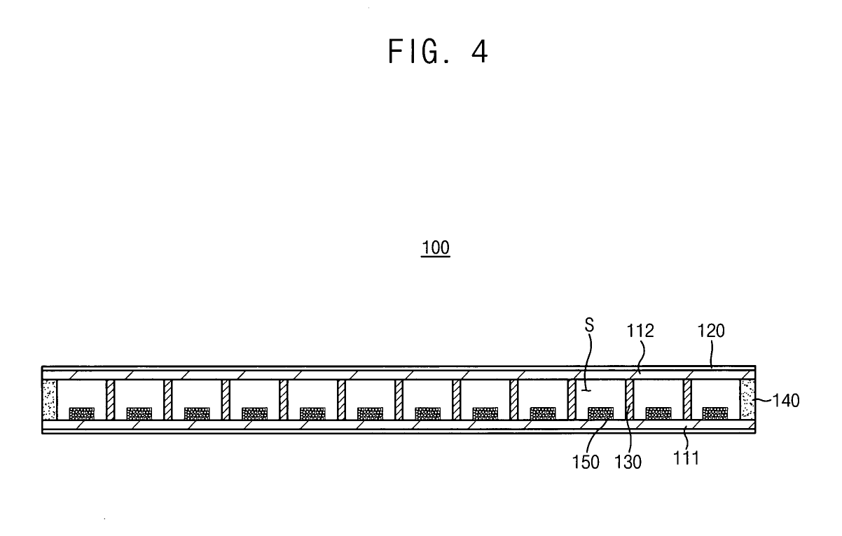

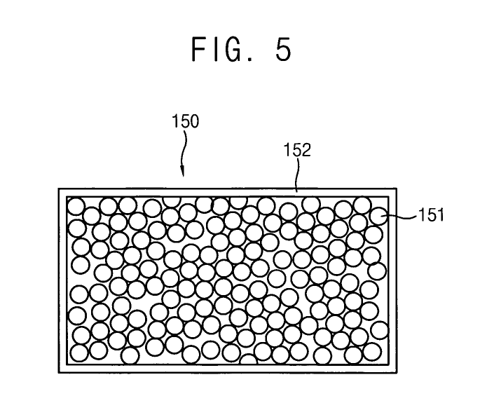

FIG. 3 is a perspective view illustrating a surface light source device in accordance with a first exemplary embodiment of the present invention. FIG. 4 is a cross sectional view taken along a line IV-IV′ in FIG. 3. FIG. 5 is an enlarged cross sectional view illustrating a porous internal electrode in FIG. 4.

Referring to FIGS. 3 and 4, a surface light source device 100 of the present embodiment includes a light source body 110 having an inner space into which a discharge gas is injected, an external electrode 120 for applying a discharge voltage to the discharge gas to form plasma, and a porous internal electrode 150 for supplying secondary electrons to the plasma. Examples of the discharge gas include a mercury gas, an argon gas, a neon gas, a xenon gas, etc. These can be used alone or in a combination thereof.

The surface light source device 100 of the present embodiment is a partition wall-separated type. Thus, the light source body 110 includes a first substrate 111, a second substrate 112 positioned over the first substrate 111, a sealing member 140 interposed between edges of the first and second substrates 111 and 112 to define the inner space into which the discharge gas is injected, a plurality of partition walls 130 arranged in the inner space to divide the inner space into a plurality of discharge spaces S, and the porous internal electrode 150 for applying the secondary electrons to the plasma.

The partition walls 130 are arranged along a first direction substantially in parallel with each other. According to the present embodiment, in order to connect adjacent two discharge spaces S to each other, a gas passage (not shown) is formed through each of the partition walls 130 or the partition walls 130 are arranged in a serpentine shape.

The first and second substrates 111 and 112 include a glass material that transmits visible rays and blocks ultraviolet rays. The second substrate 112 includes a light exiting face that exits a light generated in the discharge spaces S. A first passivation layer (not shown) may be formed on the first substrate 111 and a second passivation layer (not shown) may be formed beneath the second substrate 112.

In additional, a reflection layer (not shown) may be formed on a surface of the first substrate 111. The reflection layer may include a titanium oxide (TiO₃) film, an aluminum oxide (Al₂O₃) film, etc. The reflection layer such as the TiO₃ film or the Al₂O₃film may be formed by a chemical vapor deposition (CVD) process, sputtering process, etc. The reflection layer reflects the visible ray toward the first substrate 111 to the second substrate 112 for enhancing luminance of the surface light source device 100.

A first fluorescent layer (not shown) for converting the ultraviolet ray in the discharge spaces S into a visible light may be formed on the reflection layer. In addition, a second fluorescent layer (not shown) may be formed beneath the second substrate 112.

A pair of the external electrodes 120 connected to a power supply is formed on both outer faces of the first and second substrates 111 and 112, respectively. The external electrodes 120 are arranged in a second direction substantially perpendicular to the first direction. Therefore, the external electrodes 120 are substantially perpendicular to the partition walls 130. Examples a metal that may be used for the external electrode 120 may include copper (Cu), nickel (Ni), tungsten (W), etc.

The porous internal electrode 150 is arranged in the light source body 110. The porous internal electrode 150 is a floating electrode that is not connected to the power supply. In particular, the porous internal electrode 150 is placed in both edge portions of the discharge space S corresponding to positions of the external electrode 120. The porous internal electrode 150 provides the secondary electrons to the plasma that is generated by applying the discharge voltage to the external electrode 120. In particular, ions excited from the discharge gas collide against the porous internal electrode 150 in the discharge space S. Therefore, the secondary electrons are continuously emitted from the porous internal electrode 150 so that an amount of the plasma is steadily maintained.

Therefore, an intensity of the electric field is increased due to the secondary electrons supplied from the porous internal electrode 150 so that the initial discharge voltage may be decreased. In addition, cathode-dropping voltage that is required to properly maintain the plasma may be decreased due to the secondary electrons so that a voltage that is consumed in the non-light emitting region may be reduced. Furthermore, since energy consumption in a light-emitting region is increased due to the secondary electrons supplied from the non-light-emitting region to the light-emitting region, efficiency for converting energy into a light may be improved.

Referring to FIG. 5, the porous internal electrode 150 includes a porous member 151, and a conductive layer 152 formed on an outer surface of the porous member 151.

The porous member 151 has a plurality of voids. When a diameter of the voids has no more than about 30 μm, the conductive layer 152 is not easily coated on inner faces of the voids. On the contrary, when the diameter of the voids has no less than 300 μm, an area of the porous internal electrode 150 is reduced so that a desired effect of emitting the secondary electrons is not generated. Thus, the diameter of the voids of the porous member 51 is about 30 μm to about 300 μm. In this embodiment, an example of the porous member 151 includes a ceramic material.

Meanwhile, examples of the conductive layer 152 include copper (Cu), nickel (Ni), and tungsten (W), etc. In this embodiment, the material of the conductive layer 152 is substantially identical to that of the external electrode 120.

### Embodiment 2

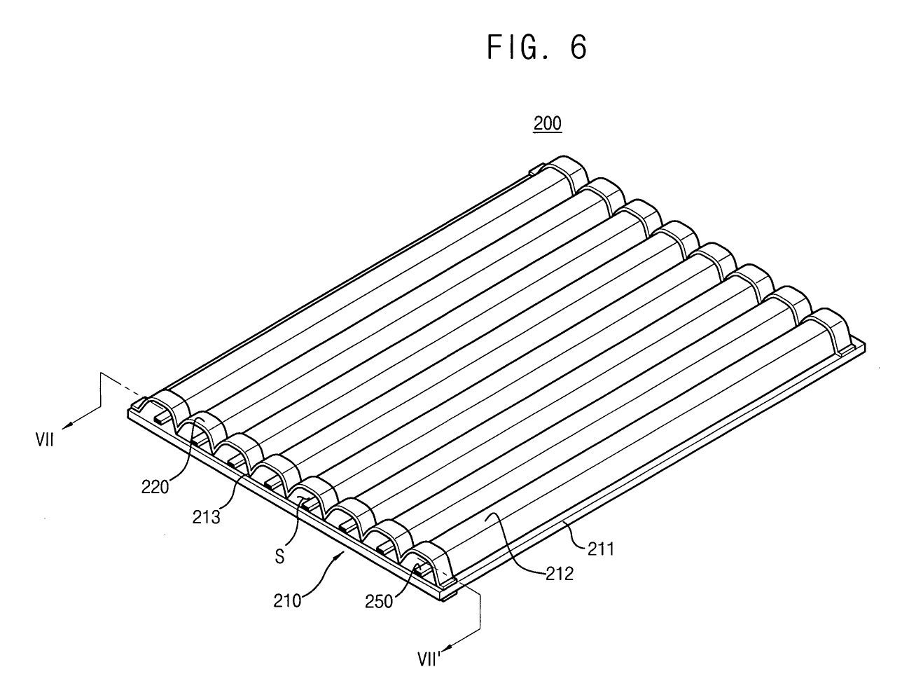

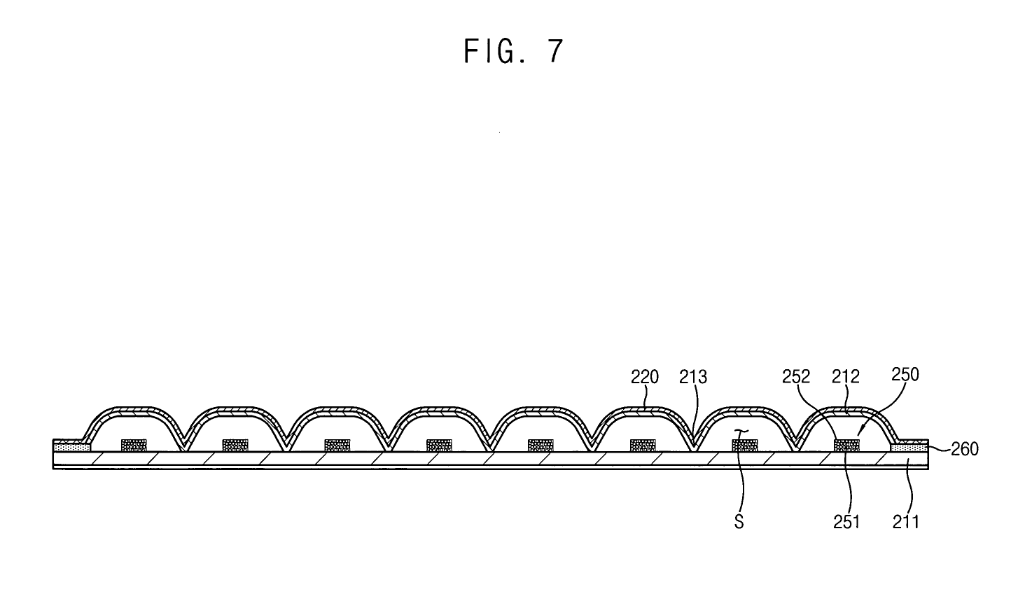

FIG. 6 is a perspective view illustrating a surface light source device in accordance with a second exemplary embodiment of the present invention. FIG. 7 is a cross sectional view taken along a line VII-VII′ in FIG. 6.

Referring to FIGS. 6 and 7, a surface light source device 200 according to the second exemplary embodiment includes a light source body 210 having a inner space into which discharge gas is injected, an external electrode 220 for supplying a discharge voltage to the discharge gas to generate plasma from the discharge gas, and a porous internal electrode 250 for providing secondary electrons to the plasma.

The light source body 210 is a partition wall-integrated type. Thus, the light source body 210 includes a first substrate 211, a second substrate 212 placed over the first substrate 211. The second substrate 212 is integrally formed with partition wall portions 213. The partition wall portions 213 make contact with the first substrate 211 to form a plurality of discharge spaces S into which discharge gas is injected. Two outermost partition wall portions are attached to the first substrate 211 using a frit 260. The partition wall portions 213 are arranged in a first direction substantially in parallel with each other. In particular, the partition wall portions 213 may have a width of about 1 mm to about 2 mm. To connect adjacent two discharge spaces S, at least one connecting hole may be formed through each of the partition wall portions 213 or at least two partition wall portions 213 are arranged in a serpentine shape.

The external electrodes 220 are formed on outer faces of the edge portions of the first substrate 211 and the second substrate 212. The porous internal electrodes 250 are arranged in both edge portions of each of the discharge spaces S corresponding to the external electrode 220, respectively. The porous internal electrode 250 includes a porous member 251, and a conductive layer 252 formed on outer faces of the porous member 251. The porous member 251 has a plurality of voids.

### Embodiment 3

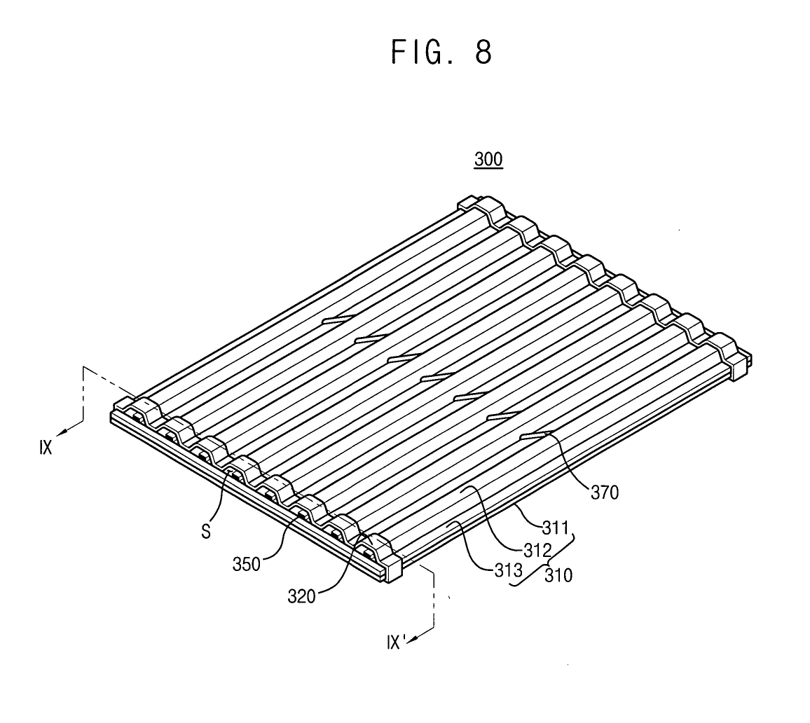

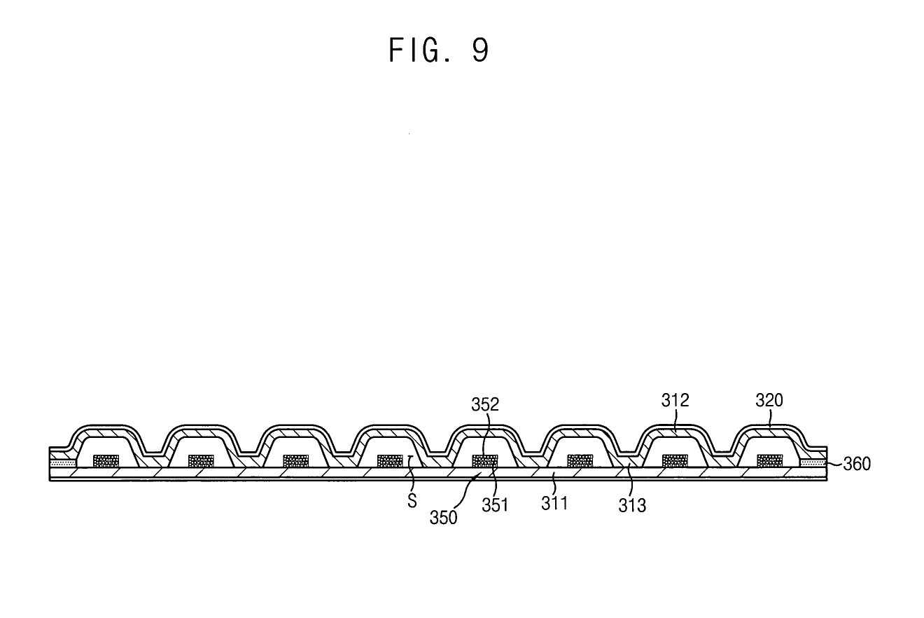

FIG. 8 is a perspective view illustrating a surface light source device in accordance with a third exemplary embodiment of the present invention. FIG. 9 is a cross sectional view taken along a line IX-IX′ in FIG. 8.

Referring to FIGS. 8 and 9, a surface light source device 300 according to the third exemplary embodiment is a partition wall-integrated type. Therefore, the light source body 310 includes a first substrate 311, and a second substrate 312 positioned over the first substrate 311 and having a plurality of partition wall portions that are integrally formed with the second substrate 312. Outermost partition wall portions 312 are attached to the first substrate 311 using a frit 260. In particular, the partition wall portions 313 may have a width of about 3 mm to about 5 mm, preferably about 4 mm so as to suppress a current drift effect between adjacent two discharge spaces S through the partition wall portions 313.

To connect adjacent two discharge spaces S, at least one connecting passage 370 is formed through the partition wall portions 313. In this embodiment, each of the partition wall portions 313 has the connecting passage 370 inclined by an acute angle with respect to a first direction. Alternatively, the connecting passage 370 may be formed along a second direction substantially perpendicular to the first direction.

For example, a pair of external electrodes 320 electrically connected to a power supply is formed on both faces of the first and second substrate 311 and 312. A porous internal electrode 350 is arranged in the light source body 310. In particular, the porous internal electrode 350 is arranged in both edge portions of the discharge space S corresponding to the external electrodes 320.

### Embodiment 4

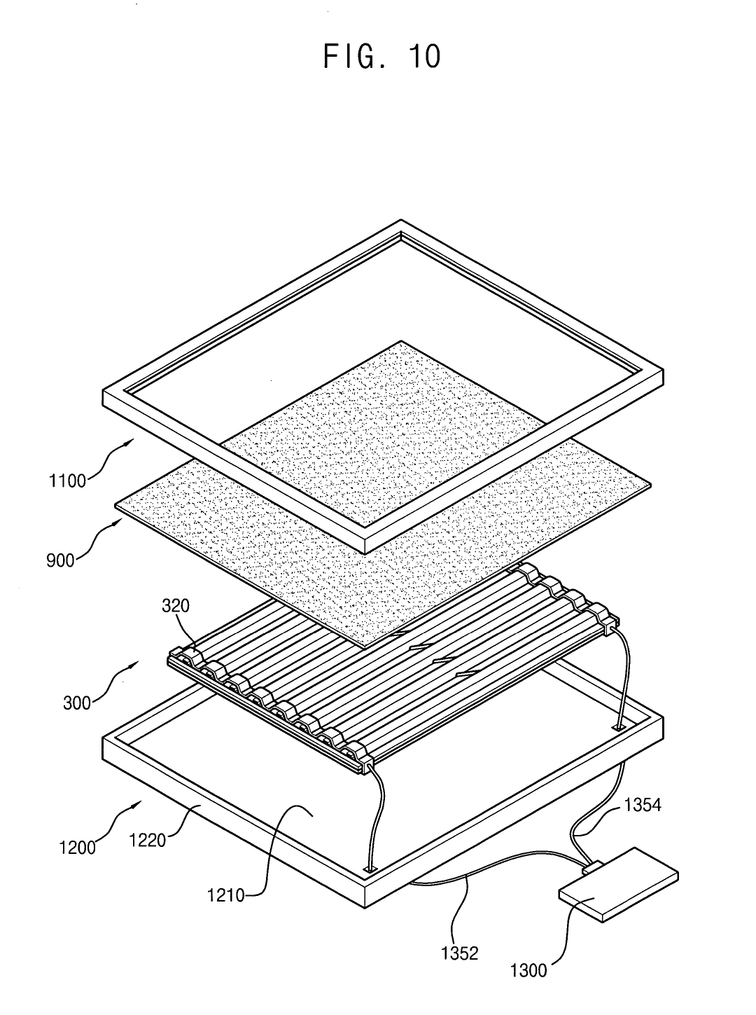

FIG. 10 is an exploded perspective view illustrating a back light unit in accordance with a fourth embodiment of the present invention.

Referring to FIG. 10, a back light unit 1000 in accordance with the present embodiment includes the surface light source device 300 according to the third exemplary embodiment, upper and lower cases 1100 and 1200, an optical member 900 and an inverter 1300.

The surface light source device 300 is illustrated in detail with reference to FIG. 8. Thus, any further illustrations of the surface light source device 300 are omitted. Further, other surface light source devices in accordance with Embodiments 1 and 2 may be employed in the back light unit 1000.

The lower case 1200 includes a bottom face 1210 for receiving the surface light source device 300, and a side face 1220 extending from an edge of the bottom face 1210. Thus, a receiving space for receiving the surface light source device 200 is formed in the lower case 1200.

The inverter 1300 is arranged under the lower case 1200. The inverter 1300 generates a discharge voltage for driving the surface light source device 200. The discharge voltage generated from the inverter 1300 is applied to the external electrode 320 of the surface light source device 300 through first and second electrical cables 1352 and 1354.

The optical member 900 includes a diffusion sheet (not shown) for uniformly diffusing a light irradiated from the surface light source device 300, and a prism sheet (not shown) for providing straightforwardness to the light diffused by the diffusion sheet.

The upper case 1100 is combined with the lower case 1220 to support the surface light source device 300 and the optical member 900. The upper case 1100 prevents the surface light source device 300 from being separated from the lower case 1200.

Additionally, an LCD panel (not shown) for displaying an image may be arranged over the uppercase 1100.

According to the present invention, the intensity of the electric field is increased due to the secondary electrons supplied from the internal electrode so that the initial discharge voltage may be decreased.

Further, cathode-dropping voltage that is required to properly maintain the plasma may be decreased due to the secondary electrons so that a voltage that is consumed in the non-light emitting region may be reduced.

Furthermore, since energy consumption in a light-emitting region is increased due to the secondary electrons provided from the non-light-emitting region to the light-emitting region, efficiency for converting energy into a light may be improved.

Having described the exemplary embodiments of the present invention and its advantages, it is noted that various changes, substitutions and alterations can be made herein without departing from the spirit and scope of the invention as defined by appended claims.

What is claimed is:

1. A surface light source device, comprising:
a light source body having a plurality of discharge spaces into which a discharge gas is injected;
an external electrode provided on the outer face of the light source body, the external electrode applying a discharge voltage to the discharge gas to generate plasma in the light source body; and
a porous internal electrode arranged in the light source body to provide secondary electrons to the plasma.

2. The surface light source device of claim 1, wherein the light source body comprises:
a first substrate;
a second substrate positioned over the first substrate;
a sealing member interposed between edge portions of the first and second substrates to define an inner space that is isolated from an exterior; and
partition walls arranged in the inner space to divide the inner space into the discharge spaces.

3. The surface light source device of claim 1, wherein the light source body comprises:
a first substrate; and
a second substrate integrally formed with partition wall portions, the partition wall portions making contact with the first substrate to form the discharge spaces.

4. The surface light source device of claim 3, wherein the partition wall portions has a width of about 3 mm to about 5 mm.

5. The surface light source device of claim 1, wherein the external electrode is formed on outer faces of both edge portions of the first and second substrates, and the porous internal electrode is arranged disposed in portions of the discharge space corresponding to positions of the external electrode, respectively.

6. The surface light source device of claim 1, wherein the porous internal electrode comprises:
a porous member; and
a conductive layer formed on an outer face of the porous member.

7. The surface light source device of claim 6, wherein the porous member has a plurality of voids having a diameter of about 30 μm to about 300 μm.

8. The surface light source device of claim 6, wherein the porous member includes a ceramic material.

9. The surface light source device of claim 6, wherein the conductive material includes copper, nickel or tungsten.

10. A back light unit comprising:
a light source body having a plurality of discharge spaces into which a discharge gas is injected, an external electrode provided on the outer face of the light source body to apply a discharge voltage to the discharge gas so as to generate plasma in the light source body, and a porous internal electrode arranged in the light source body to provide secondary electrons to the plasma;
a case for receiving the surface light source device;
an optical member interposed between the surface light source device and the case; and
an inverter for applying a discharge voltage to the electrode of the surface light source device.

11. The back light unit of claim 10, wherein the porous internal electrode comprises:
a porous member; and
a conductive layer formed on an outer face of the porous member.
